(19) United States
(12) Patent Application Publication
(10) Pub. No.: US 2018/0009498 A1
(43) Pub. Date: Jan. 11, 2018

(54) Safety Harness Assembly

(71) Applicant: Ceriann Wolter, Coleman, TX (US)

(72) Inventor: Ceriann Wolter, Coleman, TX (US)

(21) Appl. No.: 15/205,448

(22) Filed: Jul. 8, 2016

(51) Int. Cl. B62J 27/00; A62B 35/00; A41F 9/00

(52) U.S. Cl. CPC B62J 27/00; A41F 9/005; A62B 35/0025

(57) ABSTRACT

A safety harness assembly for facilitating a passenger on a motorcycle to hang onto a driver of the motorcycle includes a belt that may be worn by a driver thereby facilitating the belt to be gripped by a passenger. A harness is provided and the harness may be worn by the driver. The harness is removably coupled to the belt when the belt is worn. Thus, the harness may be gripped by the passenger.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed Under 37 CFR 1.97 and 1.98

The disclosure and prior art relates to harness devices and more particularly pertains to a new harness device for facilitating a passenger on a motorcycle to hang onto a driver of the motorcycle.

### BRIEF SUMMARY OF THE INVENTION

An embodiment of the disclosure meets the needs presented above by generally comprising a belt that may be worn by a driver thereby facilitating the belt to be gripped by a passenger. A harness is provided and the harness may be worn by the driver. The harness is removably coupled to the belt when the belt is worn. Thus, the harness may be gripped by the passenger.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a safety harness assembly according to an embodiment of the disclosure.

FIG. 2 is a back view of an embodiment of the disclosure.

FIG. 3 is a left side view of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

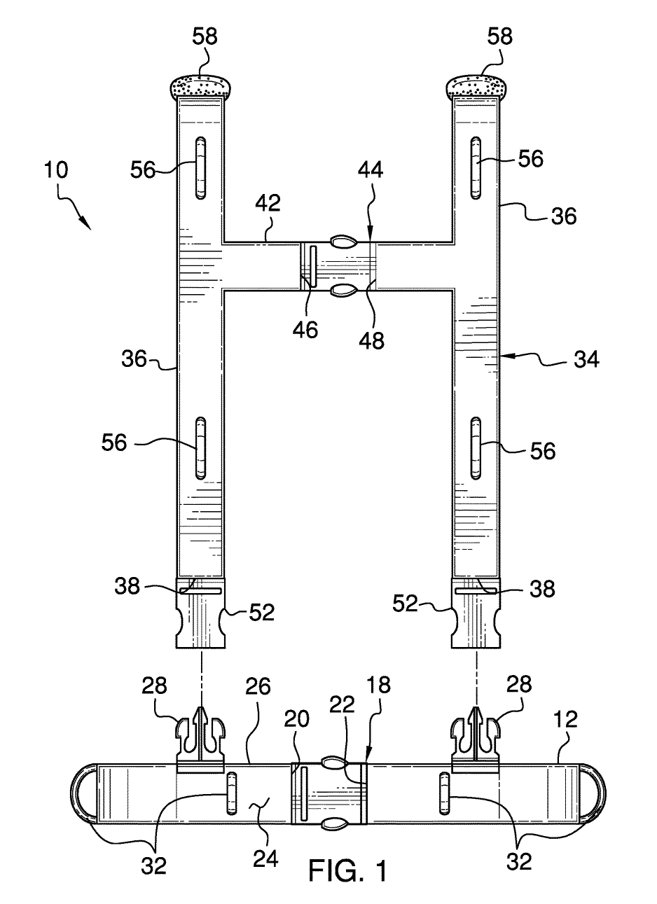

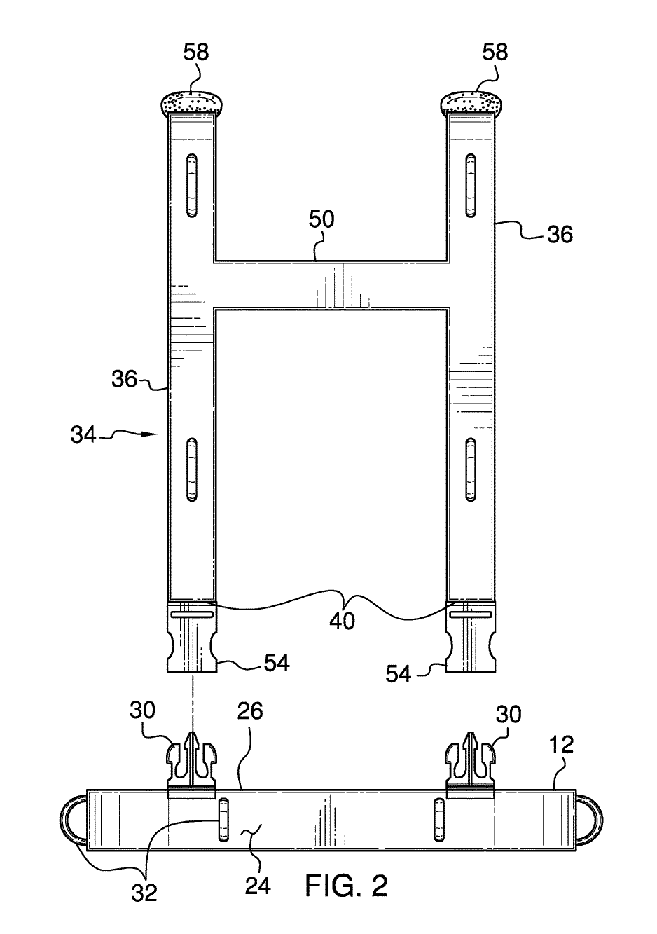

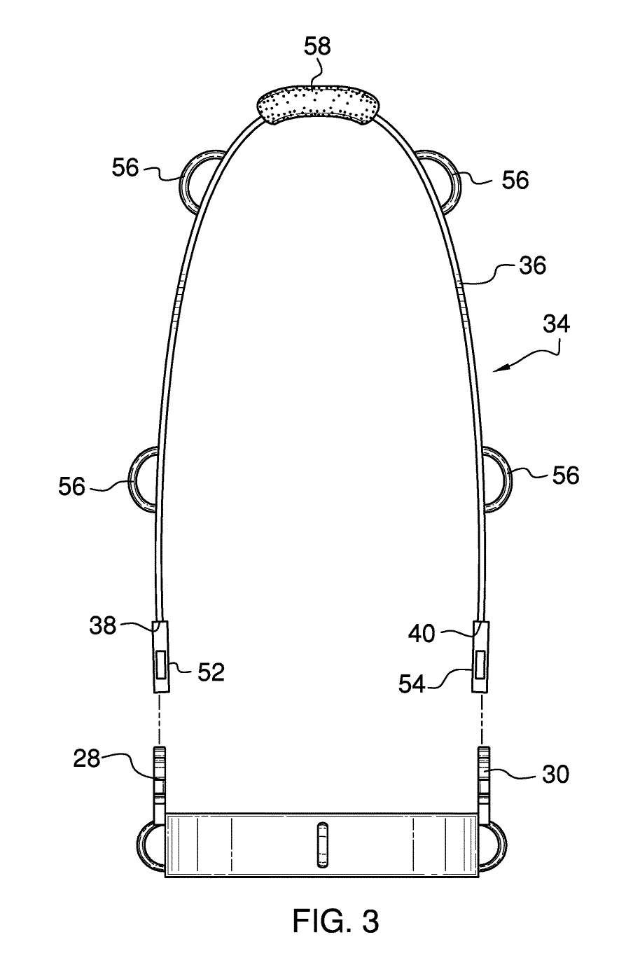

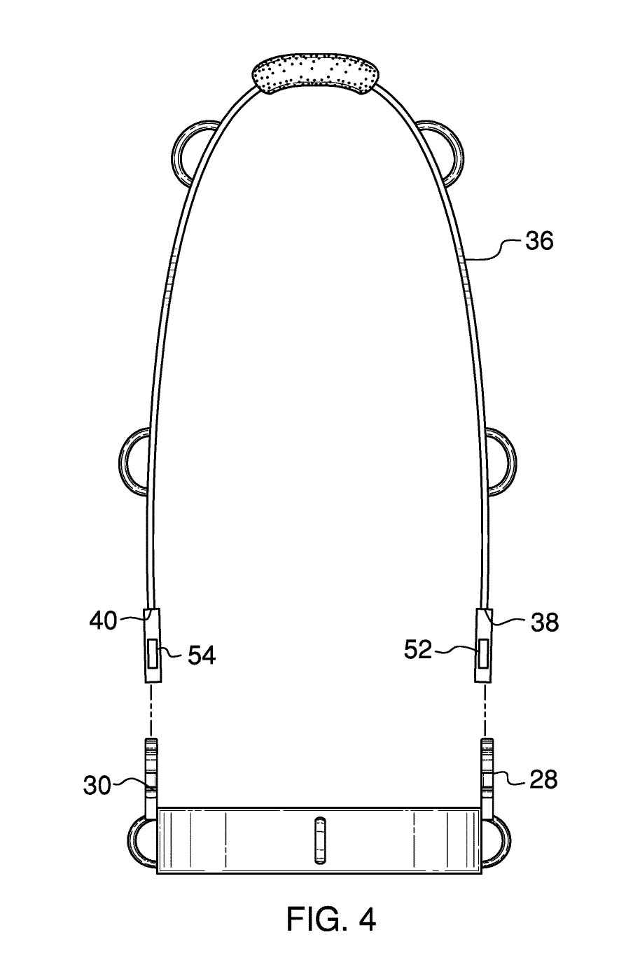

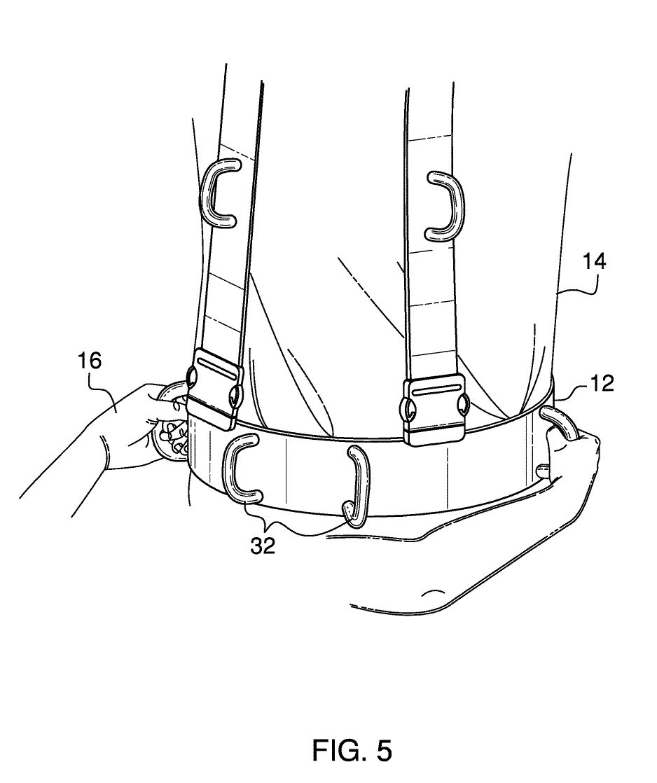

With reference now to the drawings, and in particular to FIGS. 1 through 5 thereof, a new harness device embodying the principles and concepts of an embodiment of the disclosure and generally designated by the reference numeral 10 will be described.

As best illustrated in FIGS. 1 through 5, the safety harness assembly 10 generally comprises a belt 12. The belt 12 may be worn by a driver 14 thereby facilitating the belt 12 to be gripped by a passenger 16. The driver 14 may be a motorcycle driver, an ATV driver or a horse rider. The belt 12 has a cut 18 to define a first end 20 and a second end 22 of the belt 12. The belt 12 has an outwardly facing surface 24 and a top edge 26. Each of the first end 20 and the second end 22 is matable to retain the belt 12 around a waist. A pair of complementary couplers may each be coupled to an associated one of the first end 20 and the second end 22.

A pair of first clips 28 is provided and each of the first clips 28 is coupled to the belt 30. The first clips 28 are spaced apart from each other. Each of the first clips 28 is oriented to extend upwardly from the top edge 26 of the belt 12. A pair of second clips 30 is provided and each of the second clips 30 is coupled to the belt 12. The second clips 30 are spaced apart from each other. Each of the second clips 30 is oriented to extend upwardly from the top edge 26 of the belt 12. Each of the second clips 30 is positioned on an opposite side of the belt 12 with respect to the first clips 28.

A plurality of first loops 32 is provided. Each of the first loops 32 is coupled to the belt 12. Each of the first loops 32 may be gripped when the belt 12 is worn thereby facilitating a passenger 16 to hang on. The loops 32 are spaced apart from each other and are distributed around the belt 12.

A harness 34 is provided. The harness 34 may be worn by the driver 14. The harness 34 is removably coupled to the belt 12 when the belt 12 is worn. Thus, the harness 34 may be gripped by the passenger 16. The harness 34 comprises a pair of shoulder straps 36 and each of the shoulder straps 36 may be worn over shoulders. Each of the shoulder straps 36 has a primary end 38 and a secondary end 40.

A first lateral strap 42 extends between each of the shoulder straps 36. The first lateral strap 42 has a cut 44 to define a first end 46 and a second end 48 of the first lateral strap 42. The first end 46 and the second end 48 corresponding to the first lateral strap 42 is matable to each other. The first lateral strap 42 is positioned closer to the primary end 38 than the secondary end 40. A second lateral strap 50 extends between each of the shoulder straps 36. The second lateral strap 50 is positioned closer to the secondary end 40 than the primary end 38.

A pair of primary clips 52 is provided and each of the primary clips 52 is coupled to the primary end 38 of an associated one of the shoulders straps 36. Each of the primary clips 52 is complementary with respect to an associated one of the first clips 28. A pair of secondary clips 54 is provided. Each of the secondary clips 54 is coupled to the secondary end 40 of an associated one of the shoulders straps 36. Each of the secondary clips 54 is complementary with respect to an associated one of the second clips 30.

A plurality of second loops 56 is provided. Each of the second loops 56 is coupled to an associated one of the shoulder straps 36. Thus, each of the second loops 56 may be gripped by the passenger 16. The second loops 56 are spaced apart from each other and are distributed along the shoulder straps 36.

A pair of pads 58 is provided. Each of the pads 58 is coupled to an associated one of the shoulder straps 36. Each of the pads 58 is centrally positioned on the associated shoulder strap 36. Each of the pads 58 may be comprised of a resiliently compressible material. Thus, each of the pads 58 may enhance comfort of the shoulder straps 36.

In use, the belt 12 is worn when the driver 14 mounts the horse. The passenger 16 grips the first loops 32 when the passenger 16 mounts the horse. Thus, the driver 14 may move freely on the horse while the passenger 16 hangs on. The belt 12 is worn and the harness 34 is worn when the driver 14 mounts the motorcycle and the ATV. The passenger 16 grips the first loops 32 and the second loops 56 when the passenger 16 mounts the motorcycle and the ATV. Thus, the driver 14 may move freely to control the motorcycle and the ATV while the passenger 16 hangs on.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A safety harness assembly being configured to facilitate a motorcycle passenger a means of hanging on, said assembly comprising:
a belt being configured to be worn by a driver thereby facilitating said belt to be gripped by a passenger; and
a harness being configured to be worn by the driver, said harness being removably coupled to said belt when said belt is worn wherein said harness is configured to be gripped by the passenger.

2. The assembly according to claim 1, wherein said belt has a cut to define a first end and a second end of said belt, said belt having an outwardly facing surface and a top edge, each of said first end and said second end being matable wherein said belt is configured to be retained around a waist.

3. The assembly according to claim 2, further comprising a pair of first clips, each of said first clips being coupled to said belt, said first clips being spaced apart from each other, each of said first clips being oriented to extend upwardly from said top edge of said belt.

4. The assembly according to claim 3, further comprising a pair of second clips, each of said second clips being coupled to said belt, said second clips being spaced apart from each other, each of said second clips being oriented to extend upwardly from said top edge of said belt, each of said second clips being positioned on an opposite side of said belt with respect to said first clips.

5. The assembly according to claim 2, further comprising a plurality of first loops, each of said first loops being coupled to said belt wherein each of said first loops is configured to be gripped when said belt is worn thereby facilitating a passenger to hang on, said loops being spaced apart from each other and being distributed around said belt.

6. The assembly according to claim 1, wherein said harness comprises a pair of shoulder straps, each of said shoulder straps being configured to be worn over shoulders, each of said shoulder straps having a primary end and a secondary end.

7. The assembly according to claim 6, further comprising a first lateral strap extending between each of said shoulder straps, said first lateral strap having a cut to define a first end and a second end of said first lateral strap, said first end and said second end corresponding to said first lateral strap being matable to each other, said first lateral strap being positioned closer to said primary end than said secondary end.

8. The assembly according to claim 6, further comprising a second lateral strap extending between each of said shoulder straps, said second lateral strap being positioned closer to said secondary end than said primary end.

9. The assembly according to claim 6, further comprising:
a pair of first clips; and
a pair of primary clips, each of said primary clips being coupled to said primary end of an associated one of said shoulders straps, each of said primary clips being complementary with respect to an associated one of said first clips.

10. The assembly according to claim 6, further comprising:
a pair of second clips; and
a pair of secondary clips, each of said secondary clips being coupled to said secondary end of an associated one of said shoulders straps, each of said secondary clips being complementary with respect to an associated one of said second clips.

11. The assembly according to claim 6, further comprising a plurality of second loops, each of said second loops being coupled to an associated one of said shoulder straps wherein each of said second loops is configured to be gripped by the passenger, said second loops being spaced apart from each other and being distributed along said shoulder straps.

12. The assembly according to claim 6, further comprising a pair of pads, each of said pads being coupled to an associated one of said shoulder straps, each of said pads being centrally positioned on said associated shoulder strap wherein each of said pads is configured to enhance comfort of said shoulder straps.

13. A safety harness assembly being configured to facilitate a motorcycle passenger a means of hanging on, said assembly comprising:
a belt being configured to be worn by a driver thereby facilitating said belt to be gripped by a passenger, said belt having a cut to define a first end and a second end of said belt, said belt having an outwardly facing surface and a top edge, each of said first end and said second end being matable wherein said belt is configured to be retained around a waist;
a pair of first clips, each of said first clips being coupled to said belt, said first clips being spaced apart from each other, each of said first clips being oriented to extend upwardly from said top edge of said belt;
a pair of second clips, each of said second clips being coupled to said belt, said second clips being spaced apart from each other, each of said second clips being oriented to extend upwardly from said top edge of said belt, each of said second clips being positioned on an opposite side of said belt with respect to said first clips;
a plurality of first loops, each of said first loops being coupled to said belt wherein each of said first loops is configured to be gripped when said belt is worn thereby facilitating a passenger to hang on, said loops being spaced apart from each other and being distributed around said belt;
a harness being configured to be worn by the driver, said harness being removably coupled to said belt when said belt is worn wherein said harness is configured to be gripped by the passenger, said harness comprising:
a pair of shoulder straps, each of said shoulder straps being configured to be worn over shoulders, each of said shoulder straps having a primary end and a secondary end,
a first lateral strap extending between each of said shoulder straps, said first lateral strap having a cut to define a first end and a second end of said first lateral strap, said first end and said second end corresponding to said first lateral strap being matable to each other, said first lateral strap being positioned closer to said primary end than said secondary end,
a second lateral strap extending between each of said shoulder straps, said second lateral strap being positioned closer to said secondary end than said primary end,
a pair of primary clips, each of said primary clips being coupled to said primary end of an associated one of said shoulders straps, each of said primary clips being complementary with respect to an associated one of said first clips,
a pair of secondary clips, each of said secondary clips being coupled to said secondary end of an associated one of said shoulders straps, each of said secondary clips being complementary with respect to an associated one of said second clips,
a plurality of second loops, each of said second loops being coupled to an associated one of said shoulder straps wherein each of said second loops is configured to be gripped by the passenger, said second loops being spaced apart from each other and being distributed along said shoulder straps, and
a pair of pads, each of said pads being coupled to an associated one of said shoulder straps, each of said pads being centrally positioned on said associated shoulder strap wherein each of said pads is configured to enhance comfort of said shoulder straps.
